(19) United States
(12) Patent Application Publication
(10) Pub. No.: US 2026/0030581 A1
(43) Pub. Date: Jan. 29, 2026

(54) FACILITY OPERATION SUPPORT APPARATUS, METHOD, AND PROGRAM

(71) Applicant: Hitachi, Ltd., Tokyo (JP)

(72) Inventors: Yuzuru MAYA, Tokyo (JP); Hidenori YAMAMOTO, Tokyo (JP); Hideya YOSHIUCHI, Tokyo (JP); Takaaki HARUNA, Tokyo (JP); Osamu TOMOBE, Tokyo (JP)

(21) Appl. No.: 18/865,834

(22) PCT Filed: Feb. 15, 2023
(86) PCT No.: PCT/JP2023/005203

§ 371 Date: Nov. 14, 2024

(30) Foreign Application Priority Data
Jun. 10, 2022 (JP) 2022-094061

(51) Int. Cl. G06Q 10/0635; G06Q 10/0631

(52) U.S. Cl. CPC G06Q 10/0635; G06Q 10/06313

(57) ABSTRACT

Execution of a job, such as a power grid recovery plan in a facility, is implemented to be accurately suited to an actual condition. A UI unit is configured to receive sensor data regarding the operation of the power grid. A degree of certainability of the sensor data is calculated that is defined by a combination of a plurality of elements regarding acquisition of the sensor data and certainability of the operation data. A data reproduction unit is configured to reproduce the sensor data according to the degree of certainability; and a data storage unit is configured to store the operation data and the degree of certainability of the operation data in a storage unit in association with each other. The operation plan of the facility is made using the operation data stored in the storage unit in accordance with the degree of certainability stored in the storage unit.

### TECHNICAL FIELD

The present invention relates to data management corresponding to a degree of certainability and particularly relates to a technique for supporting execution of a job using the data.

### BACKGROUND ART

Currently, in various fields, a job using data is executed. At this time, in order to appropriately execute the job, the degree of certainability of data needs to be considered. When the job is executed using data having a low degree of certainability, information processing such as analysis suited to an actual condition is not executed. Therefore, the job to be executed also deviates from the actual condition. For example, the accuracy of a plan that is made for executing the job may decrease such that the plan is inefficient or difficult to implement.

Therefore, in order execute the job, it is required to make a more accurate plan. For example, PTL 1 describes “an object is to provide a task to be executed and required information with an appropriate content at an appropriate timing in order to make an n effective decision during disaster or the like where an unpredictable situation may occur”. Here, PTL 1 describes “regarding original data or processed data, information source and a transition thereof (a route through which the data is collected) are traced to analyze the reliability”. Using the data of which the reliability is analyzed, a resource delivery plan including a route is made as a task.

### CITATION LIST

### Patent Literature

PTL 1: JP2013-088829A

### SUMMARY OF INVENTION

### Technical Problem

Here, in PTL 1, the reliability is analyzed based on the information source and the transition. Therefore, in order to ensure the degree of accuracy of the reliability, factors of the analysis such as the information source or the transition need to be accurately analyzed. However, PTL 1 does not consider this accurate analysis. Therefore, it is difficult to execute a job more suited to an actual condition.

Accordingly, an object of the present invention is to implement execution of a job such as plan making in a facility more accurately to be suited to an actual condition.

### Solution to Problem

In order to achieve the above-described object, according to the present invention, a degree of certainability of the operation data that is defined by a combination of a plurality of elements regarding acquisition of the operation data and represents certainability of the operation data is evaluated, and a job corresponding to the evaluation result is executed. The plurality of representative elements are an acquisition period element, an acquisition location element, and a characteristic element. In addition, this job includes operation support of the facility and implementation of an application service.

### Advantageous Effects of Invention

According to the present invention, more accurate job execution in a facility suited to an actual condition can be implemented.

### BRIEF DESCRIPTION OF DRAWINGS

FIG. 1 is a system configuration diagram illustrating a power grid recovery plan making support system according to a first embodiment.

FIG. 2 is a hardware configuration diagram illustrating one implementation of a power grid recovery plan support device according to the first embodiment.

FIG. 3 is a hardware configuration diagram illustrating one implementation of an electric pole sensor device according to the first embodiment.

FIG. 4 is a hardware configuration diagram illustrating one implementation of a smart meter according to the first embodiment.

FIG. 5 is a diagram illustrating the summary of a process in the first embodiment.

FIG. 6 is a sequence diagram illustrating the content of the process in the first embodiment.

FIG. 7 is a diagram illustrating a degree of certainability of data in the first embodiment and components thereof.

FIG. 8 is a diagram illustrating system configuration data used in the first embodiment.

FIG. 9 is a diagram illustrating characteristics in sensor data used in the first embodiment.

FIG. 10 is a flowchart (first) illustrating the details of a reproduction process and a storage process in the first embodiment.

FIG. 11 is a flowchart (second) illustrating the details of the reproduction process and the storage process in the first embodiment.

FIG. 12 is a flowchart illustrating the details of a continuous data missing process (1) in the first embodiment.

FIG. 13 is a flowchart illustrating the details of an inclination check process in the first embodiment.

FIG. 14 is a flowchart illustrating the details of a continuous data missing process (2) in the first embodiment.

FIG. 15 is a diagram collectively illustrating data bodies in cases 1 to 4 of the first embodiment.

FIG. 16 is a diagram collectively illustrating data bodies in cases 11 to 13 of the first embodiment.

FIG. 17 is a diagram collectively illustrating data bodies in a case 14 of the first embodiment.

FIG. 18 is a flowchart illustrating the details of a recovery plan making process in the first embodiment.

FIG. 19 is a diagram illustrating a determination process during recovery plan making in the first embodiment.

FIG. 20 is a diagram illustrating a process of making a detailed recovery plan in the first embodiment.

FIG. 21 is a diagram illustrating a route fault situation in the first embodiment.

FIG. 22 is a diagram illustrating the summary of a process of a service providing support device according to a third embodiment.

### DESCRIPTION OF EMBODIMENTS

Hereinafter, one embodiment of the present invention will be described. In the present embodiment, a facility including a plurality of equipments will be described as an example. In addition, in the present embodiment, a job plan is made as a job or an operation service corresponding to the operation plan is executed. Specifically, a facility operation support apparatus for supporting operation of a facility includes: an UI unit configured to receive operation data regarding the operation of the facility; a data evaluation unit configured to calculate a degree of certainability of the operation data that is defined by a combination of a plurality of elements regarding acquisition of the operation data and represents certainability of the operation data in accordance with the data management program; a data reproduction unit configured to reproduce the operation data according to the degree of certainability; and a data storage unit configured to store the operation data and the degree of certainability of the operation data in a storage unit in association with each other, in which an operation plan of the facility is made using the operation data stored in the storage unit in accordance with the degree of certainability stored in the storage unit.

In addition, the facility operation support apparatus according to the present embodiment for supporting operation of a facility includes: a communication device configured to receive operation data regarding the operation of the facility; a storage device connected to the communication device through a communication channel and configured to store a data management program; and an arithmetic device connected to the communication device and the storage device through the communication channel and configured to calculate a degree of certainability of the operation data that is defined by a combination of a plurality of elements regarding acquisition of the operation data and represents certainability of the operation data in accordance with the data management program, to reproduce the operation data according to the degree of certainability, and to store the operation data and the degree of certainability of the operation data in the storage device in association with each other, in which an operation plan of the facility is made using the operation data stored in the storage device in accordance with the degree of certainability stored in the storage device.

In addition, a program causing the facility operation support apparatus to function as a computer or a storage medium storing the program is also provided in the present embodiment. Further, a facility operation support method using the facility operation support apparatus is also provided in the present embodiment. Hereinafter, a more detailed example of the present embodiment will be described.

### First Embodiment

In a first embodiment, when a power grid is affected by a disaster such that a failure occurs in at least a part of the power grid where blackout occurs, recovery work will be described as an example of the job. In a facility such as a power grid including a plurality of equipment, operation data is acquired from the equipment and is operated. The equipment according to the present embodiment includes a device such as an electric pole or a smart meter.

Here, when at least a part of the equipments is affected by a disaster or the like (a failure occurs), a recovery plan corresponding to a damage situation in the equipment needs to be made. It should be noted that, when the disaster occurs, at first, the equipment affected by the disaster and the degree of the failure are unclear in many cases. In addition, when the equipment from which operation data is acquired is affected by the disaster, the degree of certainability of the operation data decreases. For example, the communication state of the smart meter is broken, the electric pole is inclined, or the normal state of the communication network itself is unclear. Therefore, a part of the operation data is missing or data deviating from an actual condition is transmitted for communication such that the degree of certainability of the operation data decreases.

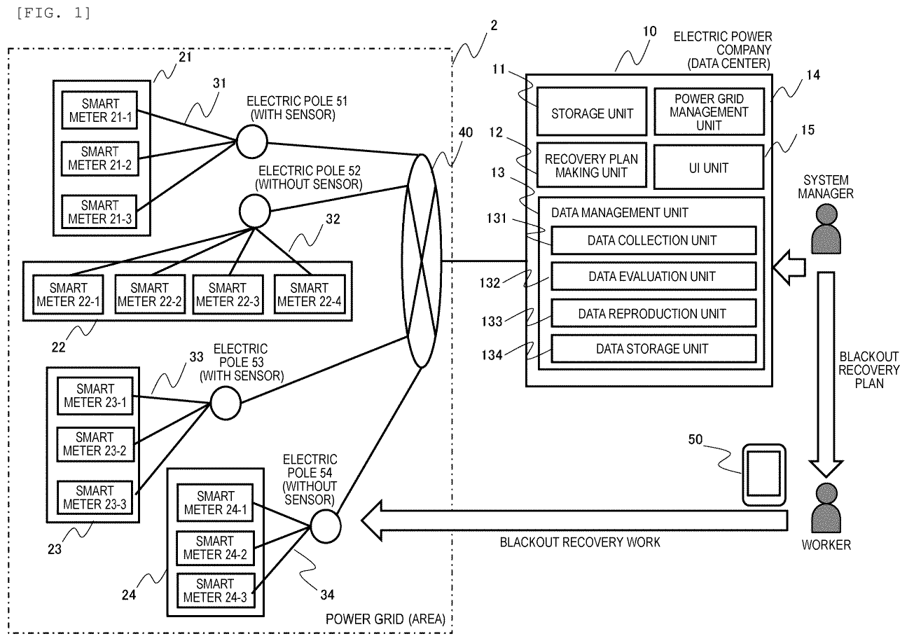

Here, in the present embodiment, when a power grid 2 is affected by the disaster such that blackout occurs, the certainability of the operation data is improved, and a blackout recovery plan corresponding to the blackout situation is made. Hereinafter, the details will be described. FIG. 1 is a system configuration diagram illustrating a power grid recovery plan making support system according to the first embodiment. In the present embodiment, the blackout recovery plan is made by a power grid recovery plan support apparatus 10 that is provided in a data center of an electric power company connected to the power grid 2. Based on the blackout recovery plan, a worker executes recovery work on the power grid 2. Therefore, the worker uses a worker terminal 50. Here, the power grid recovery plan support apparatus 10 is one kind of the facility operation support apparatus for supporting operation of the facility with the power grid 2.

In FIG. 1, the power grid 2 includes, as the equipment, smart meter groups 21 to 24, electric poles 51 to 53, lower networks 31 to 34, and an upper network 40. In addition, although not illustrated in the drawing, the power grid 2 includes an electric wire or a substation. Here, the upper network 40 is implemented in a wide area network such as the Internet.

First, the smart meter groups 21 to 24 are configured with smart meters 21-1 to 24-3 (in the drawing, indicated by smart meters) provided for each of consumers such as home. The smart meter groups 21 to 24 are connected to the electric poles 51 to 53, respectively, and are electrical energy meters that execute a metering job of each of the consumers, acquisition of an electricity usage status, or the like. That is, the smart meters 21-1 to 24-3 acquire an operation status such as a communication status as the operation data.

In addition, the electric poles 51 to 53 are connected to the smart meter groups 21 to 24 through the lower networks 31 to 34. The electric poles 51 to 53 are divided into the electric poles 51 and 53 with a sensor and the electric poles 52 and 54 without a sensor. In the electric poles 51 and 53, an electric pole sensor device 510 that detects the inclination of itself as the operation data and includes a sensor for detecting the inclination is provided.

In addition, the power grid recovery plan support apparatus 10 is connected to the electric poles 51 to 53 through the upper network 40. As a result, the power grid recovery plan support apparatus 10 collects the communication status or the inclination from the smart meters 21-1 to 24-3 or the electric poles 51 to 53. Further, the power grid recovery plan support apparatus 10 also collects the communication status of the lower networks 31 to 34 or the upper network 40. That is, the power grid recovery plan support apparatus 10 collects the operation data from the equipment. When blackout occurs, the power grid recovery plan support apparatus 10 can make the blackout recovery plan that is one kind of the operation plan from the communication status, the inclination, or the like. In addition, the power grid recovery plan support apparatus 10 outputs the blackout recovery plan.

To that end, the power grid recovery plan support apparatus 10 includes a storage unit 11, a recovery plan making unit 12, a data management unit 13, a power grid management unit 14, and an UI unit 15. The storage unit 11 stores data used for a process in the power grid recovery plan support apparatus 10. The recovery plan making unit 12 makes the blackout recovery plan from the communication status, the inclination, or the like.

The data management unit 13 manages the operation data to make the blackout recovery plan. This management includes collection of the operation data and evaluation of the degree of certainability. For the management, the data management unit 13 includes a data collection unit 131, a data evaluation unit 132, a data reproduction unit 133, and a data storage unit 134.

Here, the data collection unit 131 collects the operation data from the smart meters 21-1 to 24-3 or the electric poles 51 to 53 through the upper network 40. The data collection unit 131 may actively collect the operation data or may passively collect the operation data from each of the equipments. In addition, the data evaluation unit 132 evaluates the degree of certainability of the collected operation data. That is, the data evaluation unit 132 calculates “the degree of certainability”. It is desirable that the data evaluation unit 132 determines whether the calculated degree of certainability satisfies a predetermined condition.

Here, the degree of certainability refers to an index that is defined by a combination of a plurality of elements regarding acquisition of the operation data and represents certainability of the operation data. Therefore, the degree to which valid operation data can be acquired can be checked from the degree of certainability. One example of the degree of certainability can be defined by a plurality of elements regarding the acquisition of the operation data, such as a combination of an acquisition period element (when) of the operation data, an acquisition location element (where) thereof, and a characteristic element (what) of the operation data or the equipment. The details of the degree of certainability will be described during the description of a calculation process thereof.

In addition, the data reproduction unit 133 reproduces the collected operation data according to the evaluation result of the data evaluation unit 132. Here, the reproduction of the operation data is a process to be executed on the operation data for making the blackout recovery plan, and includes conversion for improving the degree of certainability or selection of the operation data that satisfies a predetermined condition. Further, the reproduction includes classification regarding whether the degree of certainability satisfies the predetermined condition. The data storage unit 134 stores the reproduced operation data in the storage unit 11.

In addition, the power grid management unit 14 executes the management of the power grid 2 such as acquisition of the amount of power used by each of the consumers or statistics. In addition, the UI unit 15 executes an interface function with a system manager or another device. That is, the UI unit 15 has an input/output function or a communication function.

The recovery plan making unit 12 or the power grid management unit 14 may be implemented as a separate device from the power grid recovery plan support apparatus 10 by a recovery plan making device, a power grid management device, or a combination thereof. Further, the storage unit may be independently configured, for example, as a file server.

The blackout recovery plan can be displayed on the worker terminal 50 based on the output of the above-described power grid recovery plan support apparatus 10. As a result, the worker can execute the blackout recovery work using the worker terminal 50. Here, the worker terminal 50 is used for managing the power grid 2 or each of the equipments configuring the power grid 2, and thus can be implemented by a computer such as a smartphone, a mobile phone, a tablet, a smart speaker, or a PC.

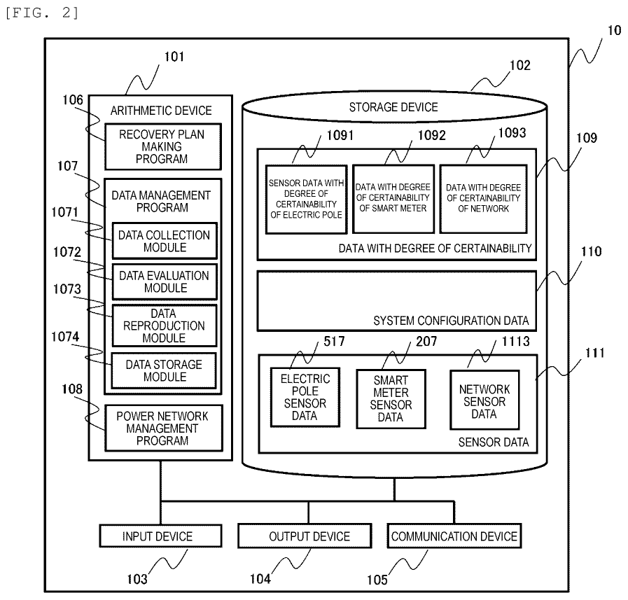

Next, configuration of each of the devices configuring the power grid recovery plan making support system will be described. FIG. 2 is a hardware configuration diagram illustrating one implementation of the power grid recovery plan support apparatus 10 according to the first embodiment. The power grid recovery plan support apparatus 10 can be implemented by a computer, includes an arithmetic device 101, a storage device 102, an input device 103, an output device 104, and a communication device 105, and connects these devices through a communication channel.

First, the arithmetic device 101 can be implemented by a processor such as a CPU (Central Processing Unit) and executes an arithmetic operation in accordance with a recovery plan making program 106, a data management program 107, and a power grid management program 108. Each of these programs will be described below.

In addition, the storage device 102 corresponds to the storage unit 11 of FIG. 1 and stores various data. The stored data includes data 109 with the degree of certainability, system configuration data 110, and sensor data 111. Although each of the data will be described below in detail, the sensor data 111 is an example of the operation data. The storage device 102 can be implemented by a temporary storage device such as a memory and a storage such as a HDD (Hard Disk Drive), an SSD (Solid State Drive), or a memory card. Here, it is desirable that not only the above-described data but also each of the programs are also stored in the storage. When a process is executed by the arithmetic device 101, a program or data related to the process is loaded from the storage to the temporary storage device. As described above, the program is stored in the storage medium.

Here, each of the above-described programs will be described. First, the recovery plan making program 106 is a program for implementing the function of the recovery plan making unit 12 of FIG. 1. In addition, the data management program 107 is a program for implementing the function of the data management unit 13 of FIG. 1. Therefore, the data management program 107 includes a data collection module 1071, a data evaluation module 1072, a data reproduction module 1073, and a data storage module 1074.

These modules implements the functions of the data collection unit 131, the data evaluation unit 132, the data reproduction unit 133, and the data storage unit 134 of FIG. 1, respectively. These modules may be implemented by independent programs, and at least a part thereof may be implemented by one module or program.

In addition, the power grid management program 108 is a program for implementing the function of the power grid management unit 14 of FIG. 1. In the present embodiment, each of the functions is implemented by the program, that is, the software. However, each of the functions may be implemented by dedicated hardware. Hereinabove, the description of each of the programs ends.

In addition, the input device 103 receives an operation from the system manager. Therefore, the input device 103 can be implemented by, for example, a keyboard, a mouse, or a microphone. The output device 104 can be implemented by, for example, a display monitor or a speaker. In addition, the input device 103 and the output device 104 can also be implemented by an integrated configuration such as a touch panel. Further, the input device 103 and the output device 104 do not need to be provided. In this case, an input can be received or information can be output by a terminal device that is used by the system manager. Further, the communication device 105 is connected to the upper network 40 or the worker terminal 50. The input device 103, the output device 104, and the communication device 105 correspond to the UI unit 15 of FIG. 1.

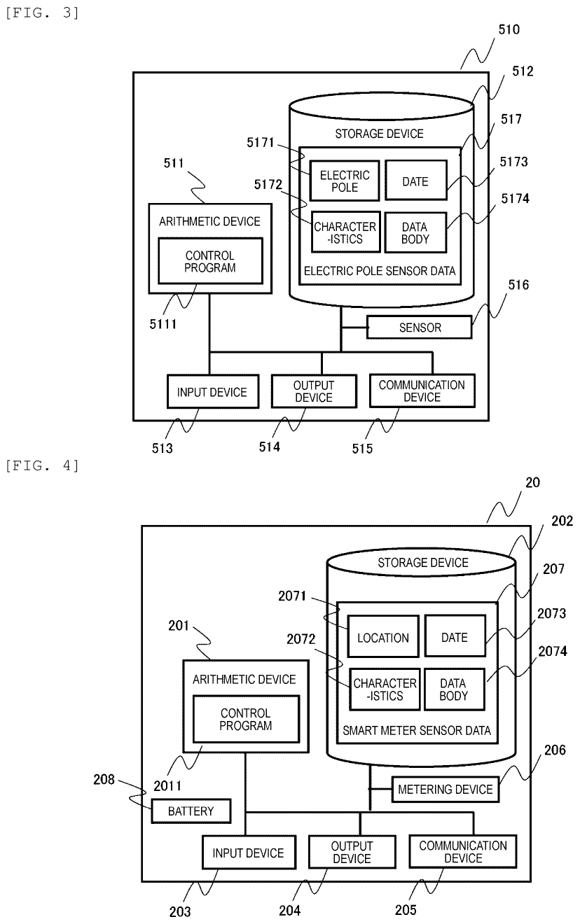

Next, the electric pole sensor device 510 provided in the electric poles 51 and 53 will be described. FIG. 3 is a hardware configuration diagram illustrating one implementation of the electric pole sensor device 510 according to the first embodiment. The electric pole sensor device 510 includes an arithmetic device 511, a storage device 512, an input device 513, an output device 514, a communication device 515, and a sensor 516, and connect the devices to each other through a communication channel. The arithmetic device 511 can be implemented by a processor such as a CPU, and the operation of the electric pole sensor device 510 is controlled in accordance with a control program 5111. The arithmetic device 511 may be implemented by dedicated hardware.

The storage device 512 stores electric pole sensor data 517 including the content detected by the sensor 516 described below. The electric pole sensor data 517 is one kind of the operation data, and includes each of items including an electric pole 5171, characteristics 5172, a date 5173, and a data body 5174. The electric pole sensor data 517 includes the sensor data 111 and is an example of the operation data.

Here, the electric pole 5171 identifies the electric pole 51 to be detected by the sensor 516 and represents the acquisition location element (where) of the electric pole sensor data 517. Therefore, the electric pole 5171 may be position information of the electric pole 51. The characteristics 5172 are the characteristic element (what) of the electric pole sensor data 517 itself or the electric pole sensor device 510 or the sensor 516 that is the device for acquiring the electric pole sensor data 517. In addition, the date 5173 represents the acquisition period element (when) of the electric pole sensor data 517. The data body 5174 is detection data representing the content detected by the sensor 516, in the present example, the inclination of the electric pole 51. The degree of certainability of the electric pole sensor data 517 is calculated, and the details thereof will be described in the description of the process of the present embodiment.

In addition, the input device 513 receives an operation from the worker or the like. Therefore, the input device 513 can be implemented by, for example, a keyboard (numeric keypad or the like) or a microphone. The output device 514 can be implemented by, for example, a display monitor or a speaker. In addition, the input device 513 and the output device 514 can also be implemented by an integrated configuration such as an operation panel. Further, the input device 513 and the output device 514 do not need to be provided.

In addition, the communication device 515 transmits and receives various data such as the electric pole sensor data 517. In particular, the communication device 515 transmits the electric pole sensor data 517 to the power grid recovery plan support apparatus 10 through the upper network 40. To that end, the communication device 515 is connected to the lower networks 31 to 34 or the upper network 40. Further, the sensor 516 detects the inclination of the electric pole 51 and outputs detection data representing the inclination. In addition, the electric pole sensor device 510 may further include a removable battery and may acquire the power from the electric pole 51.

The electric pole sensor device 510 may be implemented as the sensor 516 having a communication function. In this case, once the detection data is detected by the sensor 516, the detection data is sequentially transmitted to the power grid recovery plan support apparatus 10.

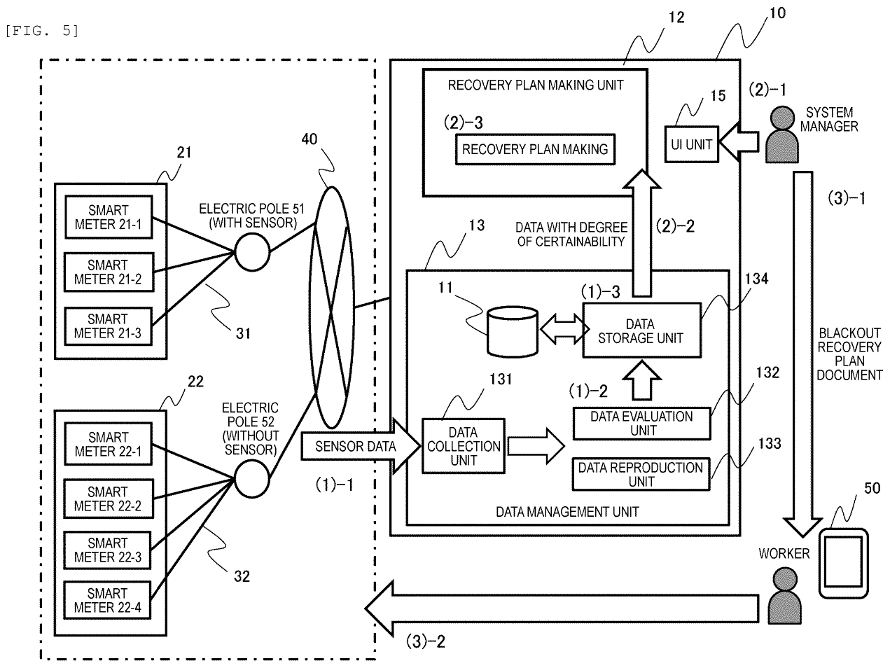

Next, the smart meters 21-1 to 24-3 will be described. Hereinafter, the smart meters 21-1 to 24-3 will be representatively referred to as the smart meter 20. FIG. 4 is a hardware configuration diagram illustrating one implementation of the smart meter 20 according to the first embodiment.

In FIG. 4, the smart meter 20 includes an arithmetic device 201, a storage device 202, an input device 203, an output device 204, a communication device 205, and a metering device 206, and connects these devices to each other through a communication channel. The smart meter 20 further includes a battery 208 as a power supply.

Here, the arithmetic device 201 can be implemented by a processor such as a CPU, and the operation of the smart meter 20 is controlled in accordance with a control program 2011. The arithmetic device 201 may be implemented by dedicated hardware.

The storage device 202 stores smart meter sensor data 207 including the amount of power used measured by the metering device 206. The smart meter sensor data 207 is one kind of the operation data, and includes each of items including a location 2071, characteristics 2072, a date 2073, and a data body 2074.

Here, the location 2071 specifies a location where the smart meter 20 is provided, and represents the acquisition location element (where) of the smart meter sensor data 207.

The location 2071 may be an item for identifying the corresponding consumer. The characteristics 2072 are the characteristic element (what) of the smart meter sensor data 207 itself or the smart meter 20 or the metering device 206 that is the device for acquiring the smart meter sensor data 207. In addition, the date 2073 represents the acquisition period element (when) of the smart meter sensor data 207. The data body 2074 is the amount of power used measured by the metering device 206. The smart meter sensor data 207 includes the sensor data 111 and is an example of the operation data. The degree of certainability of the smart meter sensor data 207 is calculated, and the details of the calculation will be described in the description of the process of the present embodiment.

In addition, the input device 203 receives an operation from the worker or the like. Therefore, the input device 203 can be implemented by, for example, a keyboard (numeric keypad or the like) or a microphone. The output device 204 can be implemented by, for example, a display monitor or a speaker. In addition, the input device 203 and the output device 204 can also be implemented by an integrated configuration such as an operation panel. Further, the input device 203 and the output device 204 do not need to be provided.

In addition, the communication device 205 transmits and receives various data such as the electric pole sensor data 517. In particular, the communication device 515 transmits the smart meter sensor data 207 to the power grid recovery plan support apparatus 10 through the lower networks 31 to 34 or the upper network 40. To that end, the communication device 515 is connected to the lower networks 31 to 34.

Further, the metering device 206 measures the amount of power used by the corresponding consumer and outputs the amount of power used. In addition, the battery 208 may be configured to be removable. Further, a power supply other than the battery 208 may be used. The smart meter 20 may be implemented as the metering device 206 having a communication function. In this case, once the amount of power used is measured by the metering device 206, the amount of power used is sequentially transmitted to the power grid recovery plan support apparatus 10. Hereinabove, the description regarding the configuration of the present embodiment ends.

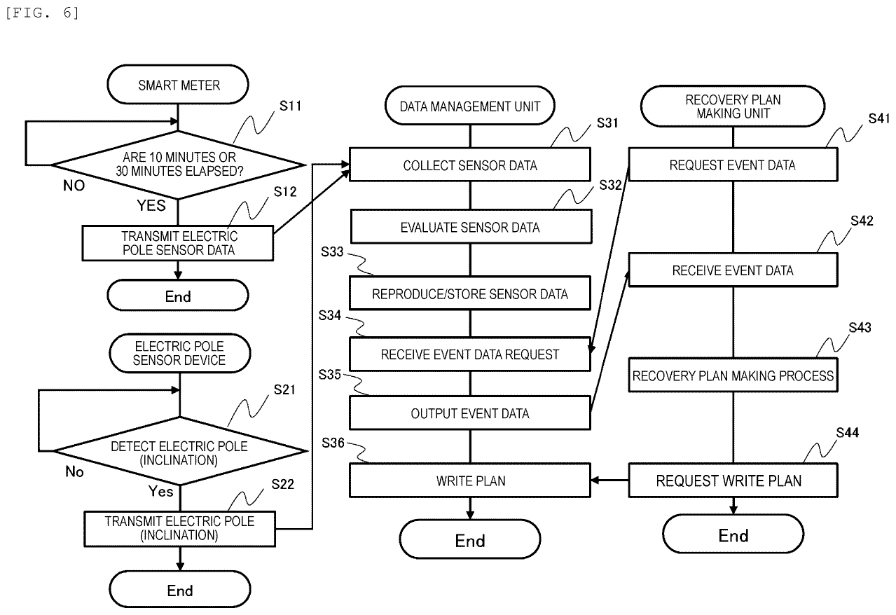

Next, the process of the first embodiment will be described. First, the summary of the process of the first embodiment will be described using FIG. 5. FIG. 5 is a diagram illustrating the summary of a process in the first embodiment.
(1) Process of Data Management Unit 13
(1)-1: The data collection unit 131 collects the electric pole sensor data 517 or the smart meter sensor data 207 as the sensor data 111 from the electric pole sensor device 510 or the smart meter 20. In addition, the data collection unit 131 collects network sensor data 1113 as the sensor data 111 regarding the upper network 40 or the lower networks 31 to 34.
(1)-2: the data evaluation unit 132 evaluates the degree of certainability of the sensor data 111 by cross-checking, and the data reproduction unit 133 executes the reproduction such as the improvement of the degree of certainability. The evaluation of the degree of certainability includes calculation of the degree of certainability from the date 5173 or 2073 that is the example of the acquisition period element, the electric pole 5171 or the location 2071 that is the example of the acquisition location element, or the characteristics 5172 or 2072 in the sensor data 111.
(1)-3: The data storage unit 134 stores the degree of certainability in (1)-2 and the sensor data 111 in the storage unit 11 in association with each other. At this time, it is desirable that the data storage unit 134 stores the degree of certainability in (1)-2 and the sensor data 111 as the data 109 with the degree of certainability.
(2) Process of Recovery Plan Making Unit 12
(2)-1: The recovery plan making unit 12 receives an instruction to make the recovery plan through an operation from the system manager.
(2)-2: In order to make the recovery plan, the recovery plan making unit 12 acquires the data 109 with the degree of certainability and the system configuration data 110. As the data 109 with the degree of certainability, the degree of certainability and the sensor data 111 may be used. In addition, the data 109 with the degree of certainability and the system configuration data 110 may be actively notified from the data management unit 13 (in particular, the data storage unit 134) to the recovery plan making unit 12.
(2)-3: As a result, the recovery plan making unit 12 makes the recovery plan using the data 109 with the degree of certainability and the system configuration data 110.
(3) Process using Worker Terminal 50
(3)-1: the made recovery plan is notified from the power grid recovery plan support apparatus 10 to the worker terminal 50. As a result, the worker can check the recovery plan. The recovery plan may be sent from the system manager to the worker through a paper medium or the like.
(3)-2: The worker moves to an area and executes the blackout recovery work based on the recovery plan.

Hereinafter, the details of the process of the first embodiment will be described. FIG. 6 is a sequence diagram illustrating the content of the process in the first embodiment. In the following description, the power grid recovery plan support apparatus 10 will be described using the configuration of FIG. 1 (the data management unit 13, the recovery plan making unit 12, or the like).

First, in Step S11, the arithmetic device 201 of the smart meter 20 determines whether a predetermined time is elapsed. For example, the arithmetic device 201 determines whether 10 minutes (30 minutes) is elapsed from the activation of the smart meter 20 or the previous process. As a result, when the predetermined time is not elapsed (NO), the present step is repeated. In addition, when the predetermined time is elapsed (YES), the process proceeds to Step S12. In the present step, the metering device 206 detects the amount of power used. The arithmetic device 201 generates the smart meter sensor data 207 from the amount of power used and stores the smart meter sensor data 207 in the storage device 202.

In addition, in Step S12, the arithmetic device 201 transmits the smart meter sensor data 207 of the storage device 202 to the power grid recovery plan support apparatus 10 using the communication device 205. As a result, the smart meter sensor data 207 generated in Step S11 is periodically transmitted.

Next, the process of the electric pole sensor device 510 that is executed in parallel with the process of the smart meter 20 will be described. First, in Step S21, the sensor 516 of the electric pole sensor device 510 continuously checks the inclination of the electric pole 51. As a result, when a predetermined inclination or more is not detected (NO), the present step continues. When the predetermined inclination or more is detected (YES), the process proceeds to Step S22. The present step continues. In the present step, the arithmetic device 511 generates the electric pole sensor data 517 based on the detection result of the sensor 516, and stores the electric pole sensor data 517 in the storage device 512.

In addition, in Step S22, the arithmetic device 511 transmits the electric pole sensor data 517 of the storage device 512 to the power grid recovery plan support apparatus 10 using the communication device 515. As a result, the smart meter sensor data 207 generated in Step S21 is periodically transmitted. The inclination of the electric pole 51 is merely an example, and data regarding operation of another electric pole may be used. For example, the amount of power application of the electric pole can be used.

Next, the process of the data management unit 13 of the power grid recovery plan support apparatus 10 will be described. First, in Step S31, the data collection unit 131 collects the electric pole sensor data 517 or the smart meter sensor data 207 transmitted in Steps S12 and S22. Further, the data collection unit 131 also collects the network sensor data 1113. This way, the data collection unit 131 collects the sensor data 111.

In addition, in Step S32, the data evaluation unit 132 executes evaluation on the collected sensor data 111. Specifically, the data evaluation unit 132 calculates the degree of certainability by cross-checking. To that end, the data evaluation unit 132 uses (Expression 1) below.

$$C = C ( when\_h ) ⋆ C ( where\_n ) * C ( what\_n ) \qquad ( Expression 1 )$$

C: the degree of certainability of the data, 0≤c(x)≤1, n=1,

where, C (when_n) represents the acquisition period element of the data, C (where_n) represents the acquisition location element of the data, and C (what_n) represents the characteristic element of the data or equipment that is a source for achieving the data.

In order to calculate the degree of certainability, (Expression 2) below may be used.

$$C = C ( when\_n ) ⋆ C ( where\_n ) * C ( what\_n ) * C ( how\_n ) \qquad ( Expression 2 )$$

C: the degree of certainability of the data, 0≤C (x)≤1, n=1,

(Expression 2) is obtained by adding a reliability enhancement functional element (how) of the data with C (how) to (Expression 1).

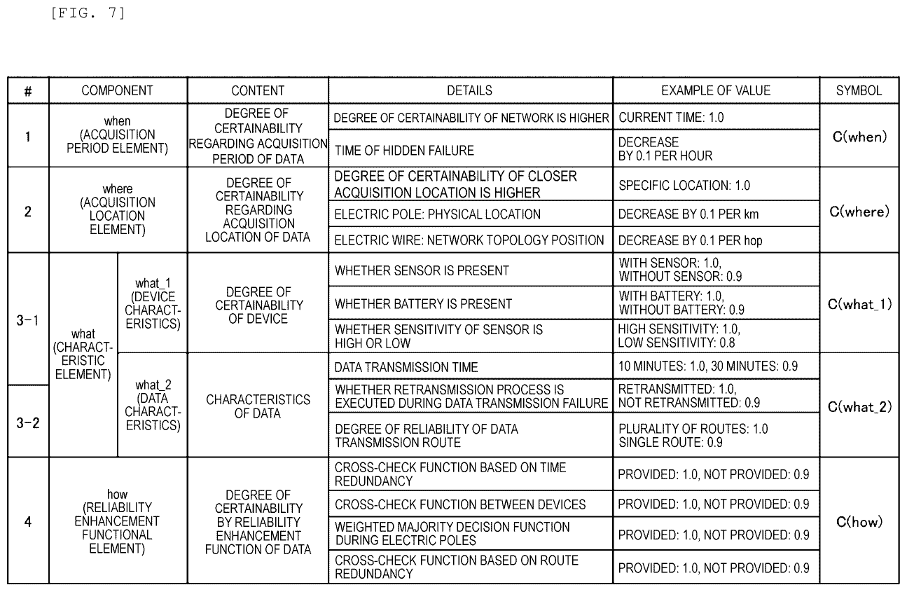

Hereinafter, the details of the degree of certainability of data will be described. FIG. 7 is a diagram illustrating the degree of certainability of data in the first embodiment and components thereof. In FIG. 7, for each of the components of the degree of certainability, the details thereof are illustrated. In FIG. 7, #1 represents the acquisition period element (when), #2 represents the acquisition location element (where), #3 represents the characteristic element (what), and #4 represents the reliability enhancement functional element (how).

First, the acquisition period element (when) represents the degree of certainability regarding the acquisition period of data such as the operation data. Regarding the acquisition period element (when), as the acquisition period of data becomes newer, the degree of certainability becomes higher. In addition, it is desirable that a period of time where a failure in the facility is hidden is also reflected on the degree of certainability. For example, assuming that the current time is 1.0, the value decreases by 0.1 per hour.

In addition, the acquisition location element (where) represents the degree of certainability regarding the acquisition location of data such as the operation data. Regarding the acquisition location element (where), as the distance between the acquisition location of data and a location such as the power grid recovery plan support apparatus 10 where data is processed becomes shorter, the values increases. The location or distance includes a physical location (position) or distance and a location (position) or distance on the network topology. For example, assuming that the acquisition location element (where) of a specific location is 1.0, the value can decrease by 0.1 per decrease of 1 km, and the value can decrease by 0.1 per decrease of 1 hop. Further, the acquisition location element (where) may be calculated using the plurality of values.

In addition, the characteristic element (what) represents the degree of certainability regarding characteristics of an equipment or device (here, referred to as a unit device) or data configuring the facility. The characteristic element (what) is a value corresponding to the certainability of the device or characteristics of data. Here, the certainability of the device is a value corresponding to the function of the device, the normality of the operation, and the certainability. For example, regarding the certainability of the device, a value corresponding to whether a sensor is present and the sensitivity of the sensor can be used. Further, the certainability of the device may be calculated using the plurality of values.

In addition, the characteristics of the data are values corresponding to the properties or characteristics of the corresponding data. For example, values corresponding to the data transmission time, whether a retransmission process is executed during transmission failure or the like, and the reliability of the transmission route can be used. Further, the characteristics of the data may be calculated using the plurality of values.

Further, the reliability enhancement functional element (how) represents the degree of certainability based on the reliability enhancement function of data. For example, as the reliability enhancement functional element (how), values corresponding to whether a cross-check function based on time redundancy is present, whether a cross-check function between devices is present, whether a weighted majority decision function between devices such as electric poles is present, and whether a cross-check function based on route redundancy is present can be used. It is desirable that these values of a case where the reliability enhancement function is present are higher than those of a case where the reliability enhancement function is not present. Further, the reliability enhancement functional element (how) may be calculated using the plurality of values.

By setting each of the above-described components to a variable of (Expression 1) or (Expression 2), the degree of certainability can be calculated. This implies that the degree of certainability is calculated by a combination of the components. Further, whether the value of the degree of certainability calculated from (Expression 1) or (Expression 2) satisfies a predetermined condition may be determined. That is, by comparing the degree of certainability to a reference value, the result may be obtained as the degree of certainability. For example, when the value of the degree of certainability is the reference value or more, the degree of certainability is evaluated as “stable”. In addition, when the value of the degree of certainability is less than the reference value, the degree of certainability is evaluated as “unstable”. Here, classification into “stable” and “unstable” is executed using an occurrence order of a failure and a hierarchical relationship (connection relationship) of the equipments in the power grid 2. In the above-described process, the degree of certainability regarding the quality of data such as data missing can be calculated. Here, when the degree of certainability is determined as unstable, it is desirable that the data collection unit 131 executes end-to-end communication with the electric pole 51 or the smart meters 21-1 to 24-3 to detect the hidden failure of the power grid 2.

Hereinabove, the description of FIG. 7 ends, and the description will be made referring back to FIG. 6. Next, in Step S33 of FIG. 6, the data reproduction unit 133 reproduces the degree of certainability specified in Step S32. The data storage unit 134 associates the degree of certainability and the sensor data 111 with each other to generate the data 109 with the degree of certainability. Here, the reproduction is a process that is executed on the sensor data 111 to make the blackout recovery plan as described above, and includes conversion and selection. Hereinafter, the details of a reproduction process and a storage process in Step S32 will be described.

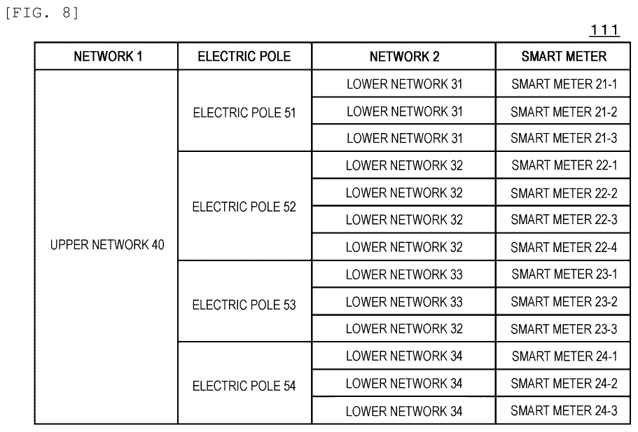

In the reproduction process and the storage process, the data reproduction unit 133 also uses the sensor data 111 (in particular, characteristics) or the system configuration data 110. Accordingly, each of the data will be described first. First, FIG. 8 is a diagram illustrating the system configuration data 110 used in the first embodiment. The system configuration data 110 is data representing the connection relationship between the equipments of the power grid 2 that is a facility to be managed. That is, as illustrated in FIG. 8, the system configuration data 110 represents a connection relationship between an upper network (network 1) and a smart meter that is a terminal. For example, the smart meter 21-1 is connected to the upper network 40 through the lower network 31 and the electric pole 51. The system configuration data 110 may be implemented as configuration data that is divided by the equipments such as the network, the electric pole, and the smart meter. That is, the system configuration data 110 can be implemented as network configuration data, electric pole configuration data, and smart meter configuration data. In this case, the system configuration data 110 can be implemented as data where each of the equipments and another equipment connected thereto are associated with each other.

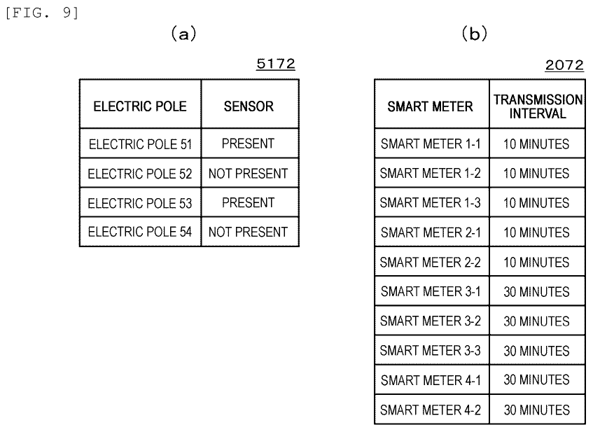

FIG. 9 is a diagram illustrating characteristics in the sensor data 111 used in the first embodiment. Among these, FIG. 9(a) illustrates the characteristics 5172 of the electric pole sensor data 517. FIG. 9(a) illustrates whether the sensor (electric pole sensor device) is present for each of the electric poles. That is, FIG. 9(a) illustrates the characteristics of the equipment of the electric pole. The reason why whether the sensor is present is illustrated is that whether to provide the sensor needs to be managed for each of the electric poles because it is difficult to provide the sensor (electric pole sensor device) in all the electric poles due to the cost.

In addition, FIG. 9(b) illustrates the characteristics 2072 of the smart meter sensor data 207. FIG. 9(b) illustrates the transmission interval of the smart meter sensor data 207 for each of the smart meters. This interval can be set for each of the smart meters, and the value thereof can be freely set.

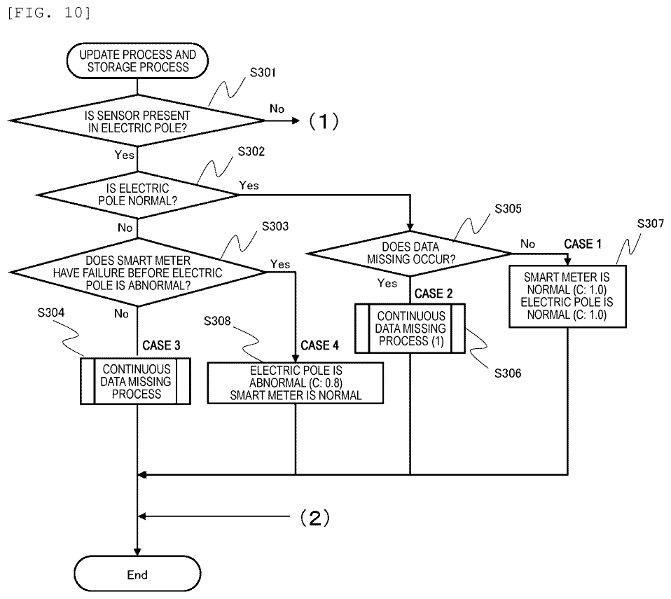

Hereinafter, the contents of the reproduction process and the storage process in Step S32 will be described. FIGS. 10 and 11 are flowcharts illustrating the details of the reproduction process and the storage process in the first embodiment.

First, in Step S301, the data reproduction unit 133 determines whether the sensor (electric pole sensor device) is present based on the characteristics S172 of the electric pole sensor data 517. As a result, when the sensor is present (Yes), the process proceeds to Step S302. In addition, when the sensor is not present (No), the process proceeds to (1) of FIG. 11. In the present step, the electric pole sensor data 517 in a predetermined period is read from the storage unit 11, and the process is executed the read data. The same also applies to the following steps.

In addition, in Step S302, the data reproduction unit 133 determines whether the corresponding electric pole is normal. To that end, the data body S174 of the electric pole sensor data 517 is used. When the inclination of the electric pole in the data body S174 is a predetermined value or less, the data reproduction unit 133 determines whether the electric pole is normal. For the determination whether the electric pole is normal, data other than the inclination may be used. As a result, when the electric pole is not normal (abnormal) (No), the process proceeds to Step S303. In addition, when the electric pole is normal (Yes), the process proceeds to Step S306. When the electric pole is abnormal, the data reproduction unit 133 specifies a time when the inclination of the electric pole is the predetermined value or more using the date S173. That is, the time when the abnormality occurs is specified.

In addition, in Step S303, the data reproduction unit 133 determines whether a failure occurs in the smart meter before occurrence of abnormality in the electric pole. To that end, the data reproduction unit 133 specifies the time when the failure occurs in the smart meter using the data body 2074 or the date 2073. As a result, when the failure does not occur (No), the process proceeds to Step S304. In addition, when the failure occurs (Yes), the process proceeds to Step S308.

In addition, in Step S304, a process of a case 3 is executed. That is, the data reproduction unit 133 executes a continuous data missing process on the target electric pole sensor data 517. Hereinafter, the details will be described. In Step S304, the electric pole sensor data 517 as the target is in a state where “the sensor is present in the electric pole” and “the electric pole is abnormal”. That is, since the electric pole includes the sensor, the reliability that the electric pole is collapsed is high. That is, the acquisition period element, the acquisition location element, and the characteristic element are all specified as 1.0 by the data reproduction unit 133. Accordingly, the degree of certainability of the target electric pole sensor data 517 is calculated as “the electric pole is abnormal (C: 1.0) “.

In addition, the smart meter sensor data 207 of the target is in a state where “continuous data missing occurs before occurrence of abnormality in the electric pole”. This way, although the electric pole is abnormal, the calculation of the degree of certainability can be classified as follows according to the missing status of the previous smart meter sensor data 207. First, in a case 3-1, the data missing of the smart meter sensor data 207 occurs only once at a final stage. In this case, the missing is estimated to be random. The characteristics of the data of the characteristic element decrease. That is, the characteristic element is 0.9. Accordingly, since the other elements are 1.0, the data reproduction unit 133 calculates the degree of certainability as “the smart meter is abnormal (C: 0.9) “.

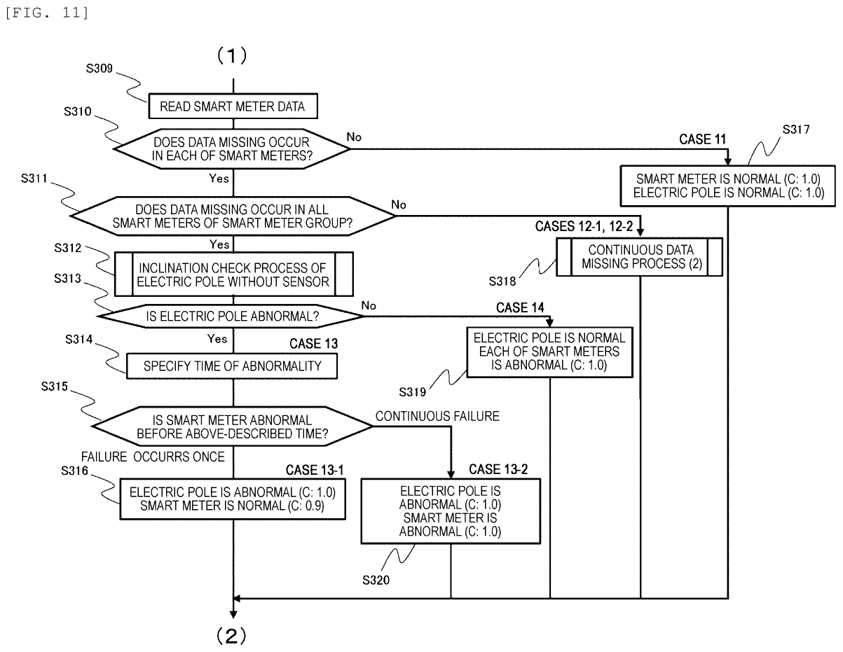

First, in a case 3-2, the electric pole is abnormal, but the data missing of the smart meter sensor data 207 is continuous. That is, it can be determined that the missing is regular and the degree of certainability is maintained. Accordingly, since the other elements are 1.0, the data reproduction 133 unit calculates the degree of certainability as “the smart meter is abnormal (C: 1.0) “. The above-described process will be described using FIG. 12. The process flow illustrated in FIG. 12 is also executed in the same manner in Step S306.

FIG. 12 is a flowchart illustrating the details of a continuous data missing process (1) in the first embodiment. First, in Step S3041, the data reproduction unit 133 determines whether missing occurs in the target electric pole sensor data 517. As a result, when the data missing is continuous (Yes), the process proceeds to Step S3042. In addition, when the data missing is not continuous (No), the process proceeds to Step S3043. Here, it is desirable that the occurrence of the missing is determined based on whether the missing occurs a predetermined number of times or more.

In addition, in Step S3042, the data reproduction unit 133 calculates the degree of certainability through the process illustrated in the above-described case 3-2. This step is also the same in a case 2-2 of Step S306 described below. In addition, in Step S3043, the data reproduction unit 133 calculates the degree of certainability through the process illustrated in the above-described case 3-1. This step is also the same in a case 2-1 of Step S306 described below. Hereinabove, the description of Step S304 ends.

First, in Step S305, the data reproduction unit 133 determines whether data missing occurs in the target electric pole sensor data 517. As a result, when the missing occurs (Yes), the process proceeds to Step S306. In addition, when the missing does not occur (No), the process proceeds to Step S307.

In addition, in Step S306, as the process of the case 2, the data reproduction unit 133 executes the same continuous data missing process (1) as that of Step S304. That is, as illustrated in FIG. 12, in Step S3041, the data reproduction unit 133 determines whether the data is missing. In addition, in Step S3042, the data reproduction unit 133 calculates the degree of certainability through the process illustrated in the above-described case 2-2. This step is also the same in a case 2-2 of Step S306 described below. In addition, in Step S3043, the data reproduction unit 133 calculates the degree of certainability through the process illustrated in the above-described case 2-1.

Here, the processes illustrated in the cases 2-1 and 2-2 will be described. In the case 2-1, the data missing of the smart meter sensor data 207 occurs only once at a final stage. In this case, the missing is estimated to be random. The characteristics of the data of the characteristic element decrease. That is, the characteristic element is 0.9. Accordingly, since the other elements are 1.0, the data reproduction unit 133 calculates the degree of certainability as “the smart meter is abnormal (C: 0.9) “.

First, in the case 2-2, the electric pole is abnormal, but the data missing of the smart meter sensor data 207 is continuous. That is, it can be determined that the missing is regular and the degree of certainability is maintained. Accordingly, since the other elements are 1.0, the data reproduction unit 133 calculates the degree of certainability as “the smart meter is abnormal (C: 1.0) “. Hereinabove, the description of Step S306 ends.

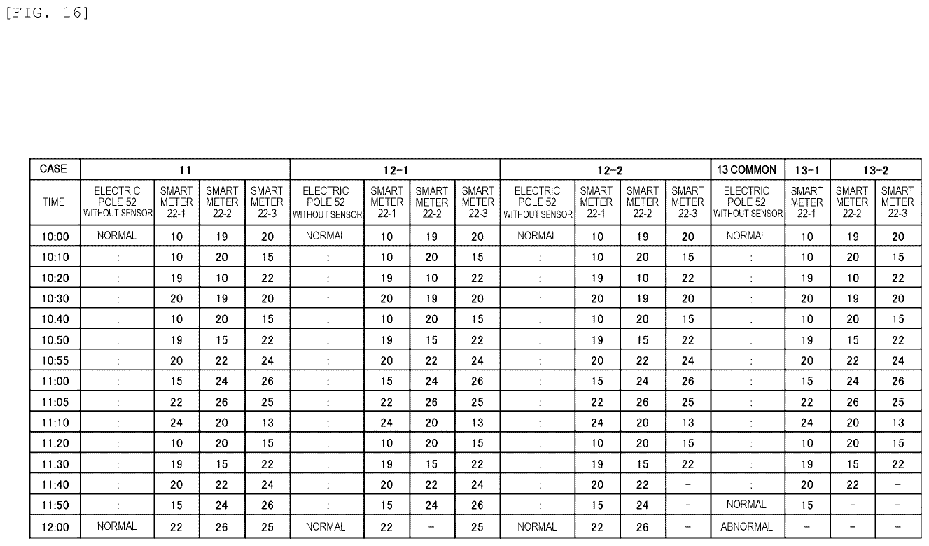

In addition, in Step S307, the data reproduction unit 133 executes the process of the case 1. That is, data reproduction unit 133 calculates that the smart meter is normal and the electric pole is normal. The data reproduction unit 133 calculates the degree of certainability of the smart meter sensor data 207 in the target electric pole sensor data 517 as 1.0. In addition, the data reproduction unit 133 calculates the degree of certainability of the target electric pole sensor data 517 as 1.0. At this time, the data reproduction unit 133 uses the data body illustrated in FIG. 15. The data body illustrated in FIG. 15 is also used in the other cases 2 to 4. FIG. 15 will be described below.

Hereinafter, the calculation of the degree of certainability will be described. In Step S307, the electric pole sensor data 517 as the target is in a state where “the sensor is present in the electric pole”, “the electric pole is normal”, and “data missing does not occur”. That is, there is no notification that the sensor is present in the electric pole and the electric pole is collapsed. That is, the acquisition period element, the acquisition location element, and the characteristic element are all specified as 1.0. As a result, the data reproduction unit 133 calculates the degree of certainability of the target electric pole sensor data 517 as 1.0.

In addition, in Step S307, data missing also does not occur in the smart meter sensor data 207. That is, the acquisition period element, the acquisition location element, and the characteristic element are all specified as 1.0. That is, the acquisition period element, the acquisition location element, and the characteristic element are all specified as 1.0. As a result, the data reproduction unit 133 calculates the degree of certainability of the smart meter sensor data 207 of the target as 1.0. Hereinabove, the description of Step S307 ends.

In addition, in Step S308, a process of a case 4 is executed by the data reproduction unit 133. Here, the electric pole sensor data 517 as the target in Step S308 has a notification that the electric pole includes the sensor and the electric pole is collapsed. That is, “the sensor is present in the electric pole” and “the electric pole is abnormal”. Therefore, as in Step S304, the data reproduction unit 133 calculates the degree of certainability of the target electric pole sensor data 517 as “the electric pole is abnormal (C: 1.0) “.

In addition, the smart meter sensor data 207 as the target is in a state where “data missing does not occur in the smart meter sensor data 207 before occurrence of abnormality in the electric pole”. This way, a failure is likely to occur in the smart meter after the abnormality of the electric pole. However, this failure cannot be detected. This failure will be referred to as the hidden failure. Accordingly, the degree of data certainability of the smart meter is calculated in consideration of hidden failure. Specifically, the data reproduction unit 133 specifies the acquisition period element based on the time that is elapsed from the failure. That is, the time of the hidden failure illustrated in FIG. 7 is used. The data reproduction unit 133 calculates the degree of certainability of the smart meter sensor data 207 using the time of the hidden failure.

Next, the process after (1) will be described using FIG. 11. In Step S309, the data reproduction unit 133 reads the corresponding smart meter sensor data 207 from the storage unit 11. In addition, in Step S310, the data reproduction unit 133 determines whether data missing occurs in the smart meter sensor data 207 in each of the smart meters 21-1 to 24-3. As a result, when the missing occurs (Yes), the process proceeds to Step S311. In addition, when the missing does not occur (No), the process proceeds to Step S317.

In addition, in Step S311, the data reproduction unit 133 determines whether data missing occurs in the smart meter sensor data 207 in each of the smart meter groups 21 to 24. As a result, when the missing occurs (Yes), the process proceeds to Step S312. In addition, when the missing does not occur (No), the process proceeds to Step S318.

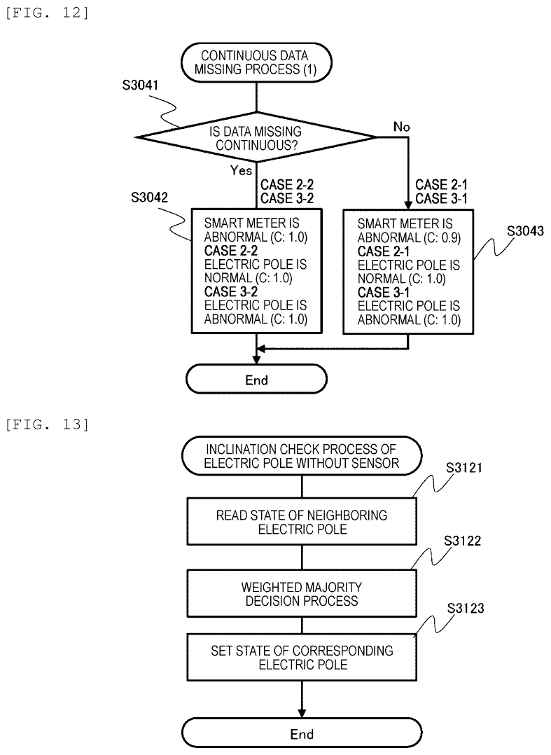

In addition, in Step S312, the data reproduction unit 133 executes an inclination check process on the electric pole where the electric pole sensor is not present. The details of the inclination check process will be described using FIG. 13. FIG. 13 is a flowchart illustrating the details of the inclination check process in the first embodiment. First, in Step S3121, the data reproduction unit 133 specifies the electric pole as the target. The data reproduction unit 133 extracts the electric pole in the vicinity of the specified electric pole. To that end, the data reproduction unit 133 extracts the neighboring electric pole having a predetermined relationship such as predetermined distance (for example, radius: 2 km) with the electric pole as the target using the system configuration data 110 or the location 2071 of the electric pole sensor data 517.

In addition, in Step S3122, the data reproduction unit 133 executes a weighted majority decision process. Hereinafter, the content will be described. The weight relates to the acquisition of data as in each of the elements, and can be grasped from each of the viewpoints of the acquisition period, the acquisition location, the characteristics, and the reliability enhancement function.

First, the data reproduction unit 133 specifies the weight using the electric pole sensor data 517 of the electric pole as the target. Specifically, the data reproduction unit 133 specifies the weight of the acquisition period from the date S173. For example, when the acquisition date of the latest electric pole sensor data 517 is 12:00, the weight of the acquisition period is 1.0. In addition, the data reproduction unit 133 specifies the weight of the acquisition location from the electric pole S171. For example, the weight of a location within 1 km is 0.9 and the weight of a location of 2 km is 0.8. This way, the acquisition location element decreases by 0.1 per km.

In addition, the data reproduction unit 133 specifies the weight of the characteristics from the characteristics S172. For example, when the electric pole sensor device is present (sensor is present), the weight is 1.0, and when the sensor is not present, the weight is 0.9. In addition, the data reproduction unit 133 executes the majority decision process, and thus the weight regarding the reliability enhancement function is 1.0.

In addition, the data reproduction unit 133 calculates the weight of the electric pole sensor data 517 for each of the electric poles using each of the weights specified as described above. Here, the weight of the target electric pole and the extracted weight of the neighboring electric pole are calculated. This calculation is executed as in (Expression 2) described above. For example, it is assumed that the degree of certainability of the target electric pole is 0.8 and the degrees of certainability of the neighboring electric poles are 0.9 and 0.72. The data reproduction unit 133 executes the majority decision process to calculate an adjusted weight based on (the weight of the neighboring electric pole)/(the weight of the neighboring electric pole+ the weight of the target electric pole). In the above-described example, (0.9+0.72)/(0.9+0.72+0.8)=0.67 is calculated as the adjusted weight.

In addition, in Step S3123, the data reproduction unit 133 calculates the degree of certainability of data according to the adjusted weight. That is, when the adjusted weight is 0.9 or more, the degree of certainability is 1.0. In addition, when the adjusted weight is 0.7 to 0.89, the degree of certainability is 0.9. Further, when the adjusted weight is 0.51 to 0.69, the degree of certainability is 0.8. In the above-described example, 0.8 is specified as the degree of certainability. The data reproduction unit 133 specifies the inclination of the target electric pole as the degree of certainability of 0.8. Here, the weight of the reliability enhancement function is used but does not need to be used.

Hereinabove, the description of Step S312 ends, and the description will be made referring back to FIG. 11. In Step S313, the data reproduction unit 133 determines whether the electric pole is abnormal (for example, collapse) using the inclination of the electric pole specified in Step S312. To that end, the data reproduction unit 133 takes the calculated degree of certainability into consideration to determine whether the inclination is a predetermined value or more. As a result, when the electric pole is abnormal (Yes), the process proceeds to Step S314. In addition, when the electric pole is no abnormal (No), the process proceeds to Step S319.

A process of a case 13 is executed in Steps S314 to 316 and S320 below. First, in Step S314, the data reproduction unit 133 specifies the occurrence time of the abnormality (failure) in Step S313 using the electric pole sensor data 517.

Here, in the electric pole sensor data 517 that is the target of the case 13, the sensor is not present in the electric pole, and the smart meter sensor data 207 is missing in each of the smart meters 21-1 to 24-3. In this case, two ways of cases 13-1 and 13-2 are assumed. In order to execute the process along the two ways, the determination process of Step S315 is executed. In Step S315, the data reproduction unit 133 determines whether abnormality occurs in the smart meter before the occurrence time specified in Step S314 using the smart meter sensor data 207. As a result, when the abnormality does not occur (the failure occurs once), the process proceeds to Step S316, and the process of the case 13-1 is executed. In addition, when the abnormality occurs (continuous failure), the process proceeds to Step S320, and the process of the case 13-2 is executed.

In Step S316, the data reproduction unit 133 executes the process of the case 13-1. In the case 13-1, it is assumed that, when the failure occurs in each of the smart meters 21-1 to 24-3, data missing occurs only once. Therefore, the data reproduction unit 133 calculates that the electric pole is abnormal (C: 1.0) and the smart meter is abnormal (C: 0.9). This process is executed as in Step S3043.

In addition, in Step S320, the data reproduction unit 133 executes the process of the case 13-2. In the case 13-2, it is assumed that, when the failure occurs in each of the smart meters 21-1 to 24-3, data missing continuously occurs. Therefore, the data reproduction unit 133 calculates that the electric pole is abnormal (C: 1.0) and the smart meter is abnormal (C: 1.0). This process is also executed as in Step S3043.

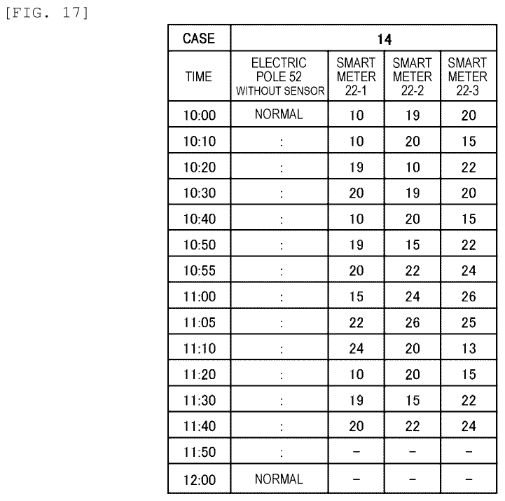

In addition, in Step S317, a process of a case 11 is executed. In the case 11, “the sensor is not present in the electric pole”, and “data missing does not occur”. Therefore, the data reproduction unit 133 determines that both of the smart meter and the electric pole are normal because the data missing also does not occur. This process is executed as in Step S307. At this time, the data reproduction unit 133 uses the data body illustrated in FIG. 16. The data body illustrated in FIG. 16 is also used in the other cases 12 and 13. FIG. 16 will be described below.

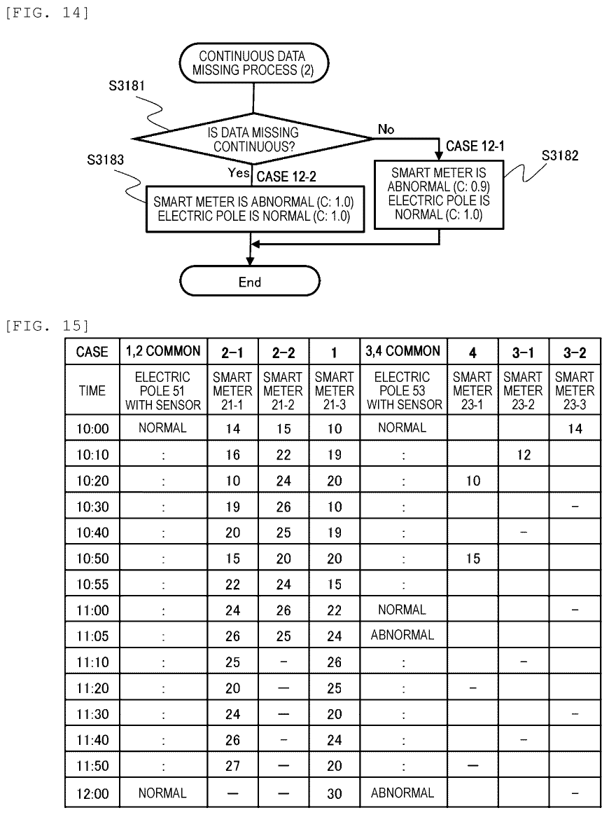

In addition, in Step S318, a continuous data missing process (2) is executed as the process of the case 12. FIG. 14 is a flowchart illustrating the details of the continuous data missing process (2) in the first embodiment. In the case 12, “the sensor is not present in the electric pole”, “the electric pole is normal”, and “data missing occurs”. In addition, since the smart meter sensor data 207 is received from a part of the smart meters, the electric pole can be determined to be normal. In this case, the case 12 is divided into the cases 12-1 and 12-2 depending on whether data missing is continuous. Accordingly, in Step S3181, the data reproduction unit 133 determines whether data missing is continuous. That is, the same process as that of Step S3041 is executed. As a result, when the data missing is continuous (Yes), the process proceeds to Step S3183. In addition, when the data missing is not continuous (No), the process proceeds to Step S3182.

In Step S3182, the process of the case 12-1 is executed. That is, the data reproduction unit 133 calculates that the electric pole is normal (C: 1.0) because there is no notification that “the sensor is present in the electric pole” and the electric pole is abnormal. In addition, the electric pole is normal, and data missing of the smart meter sensor data 207 occurs only once at a final stage, which is insufficient for determining that the smart meter is abnormal. Therefore, the data reproduction unit 133 calculates that the smart meter is abnormal (C: 0.9).

In addition, in Step S3183, a process of the case 12-2 is executed. That is, the data reproduction unit 133 executes the process based on “the sensor is present in the electric pole”, the electric pole is normal “, and “data missing occurs (continuous data missing) “. First, the data reproduction unit 133 calculates that the electric pole is normal (C: 1.0) because there is no notification that “the sensor is present in the electric pole” and the electric pole is collapsed. In addition, the data reproduction unit 133 calculates that the smart meter is abnormal (C: 1.0) because the electric pole is normal and data missing of the smart meter sensor data 207 is continuous.

In addition, in Step S319, a process of a case 14 is executed. In the case 14, “the sensor is not present in the electric pole”. Therefore, the data reproduction unit 133 determines the state of the electric pole by majority decision, that is, uses the determination result that the electric pole is normal in Step S313. Since “the sensor is not present in the electric pole”, the data reproduction unit 133 calculates that the electric pole is normal (C: 0.9). The data reproduction unit 133 calculates that the smart meter is abnormal (C: 1.0). At this time, the data reproduction unit 133 uses the data body illustrated in FIG. 17. FIG. 17 will be described below.

The data storage unit 134 stores the result determined in each of the cases in the storage unit 11. At this time, the data storage unit 134 stores the corresponding sensor data 111 (the smart meter sensor data 207 or the electric pole sensor data 517) in association with the degree of certainability. In addition, it is desirable that the data storage unit 134 associates the sensor data 111 and the degree of certainability with each other to generate the data 109 with the degree of certainability and stores the data 109 with the degree of certainability. The data 109 with the degree of certainability may be configured as data for each of the equipments, for example, data 1091 with the degree of certainability of the electric pole, data 1092 with the degree of certainability of the smart meter, and data 1093 with the degree of certainability of the network.

Hereinabove, the description of the reproduction process and the storage process ends. In the cases 1 to 3 and the cases 11, 12, 13-2, and 14, the acquisition period element, the acquisition location element, and the characteristic element are specified, and the degree of certainability is calculated using these elements. The degree of certainability may be directly calculated. That is, when a predetermined situation such as “the sensor is present in the electric pole” or “the electric pole is abnormal” is satisfied, the data reproduction unit 133 may specify the degree of certainability as 1.0.

Here, in each of the above-described cases, the data bodies 5174 and 2074 of the sensor data 111 for calculating the degree of certainability (hereinafter, the data bodies) will be described using the drawings. FIG. 15 is a diagram collectively illustrating data bodies in the cases 1 to 4 of the first embodiment. In the data bodies, whether each of the electric pole and the smart meters is normal or abnormal and the amount of power used are recorded in each of the cases. Regarding the electric pole, whether the state is normal or abnormal such as collapse. Regarding the smart meter, the amount of power used is recorded. Using these values, each of the above-described steps is executed. Regarding the smart meter, whether the state is normal or abnormal such as a fault may be recorded. Further, FIG. 15 is also data regarding “the sensor is present in the electric pole”. In FIG. 15, “-” represents data missing. This also applies to FIGS. 16 to 18 below.

FIG. 16 is a diagram collectively illustrating data bodies in the cases 11 to 13 of the first embodiment. In FIG. 16, as in FIG. 15, whether each of the electric pole and the smart meters is normal or abnormal and the amount of power used are recorded in each of the cases. FIG. 16 is also data regarding “the sensor is not present in the electric pole”. Further, FIG. 17 is a diagram collectively illustrating data bodies in the case 14 of the first embodiment. Even in FIG. 17, as in FIG. 15 or 16, whether each of the electric pole and the smart meters is normal or abnormal and the amount of power used are recorded in each of the cases. As in FIG. 16, FIG. 17 is also data regarding “the sensor is not present in the electric pole”.

Referring back to FIG. 6, the description of the overall process of the present embodiment continues. In Step S41, the recovery plan making unit 12 requests the data management unit 13 for event data used for making the recovery plan. In Step S34, the data management unit 13 receives the request for the event data from the recovery plan making unit 12. Here, the event data is data in a format used for allowing the recovery plan making unit 12 to make the recovery plan. Accordingly, the data management unit 13 (for example, the data storage unit 134) searches for the data 109 with the degree of certainability corresponding to the request and converts the searched data into the event data.

In Step S35, the data management unit 13 outputs the event data to the recovery plan making unit 12. In response to this output, the recovery plan making unit 12 receives the event data in Step S42. As the event data, the data 109 with the degree of certainability may be used. In this case, the conversion process can be skipped. In addition, the conversion into the event data may be executed by the recovery plan making unit 12.

In addition, in Step S43, the recovery plan making unit 12 executes a recovery plan making process on the disaster of the power grid 2. Here, in the present embodiment, it is desirable that the degree of certainability is recalculated to generate the recovery plan using the degree of certainability. The degree of certainability required for the recovery plan making unit 12 is does not need to be satisfied in the above-described event data or data 109 with the degree of certainability, and the verification thereof is also difficult.

Accordingly, in the present embodiment, the recovery plan making unit 12 can update and use the degree of certainability in cooperation with the data management unit 13. As a result, the recovery plan making unit 12 can use the data of the degree of certainability required for itself and can output a more appropriate process result. To that end, in Step S42 described above, the recovery plan making unit 12 outputs the request for the event data including the minimum required degree of certainability and the data management unit 13. The data reproduction unit 133 improves the degree of certainability of the target data 109 with the degree of certainability or event data to satisfy the degree of certainability from the recovery plan making unit 12 using the high reliability function. In Step S35, the data management unit 13 outputs the event data including the improved degree of certainability. In Step S43, the recovery plan making unit 12 makes the recovery plan using the received event data.

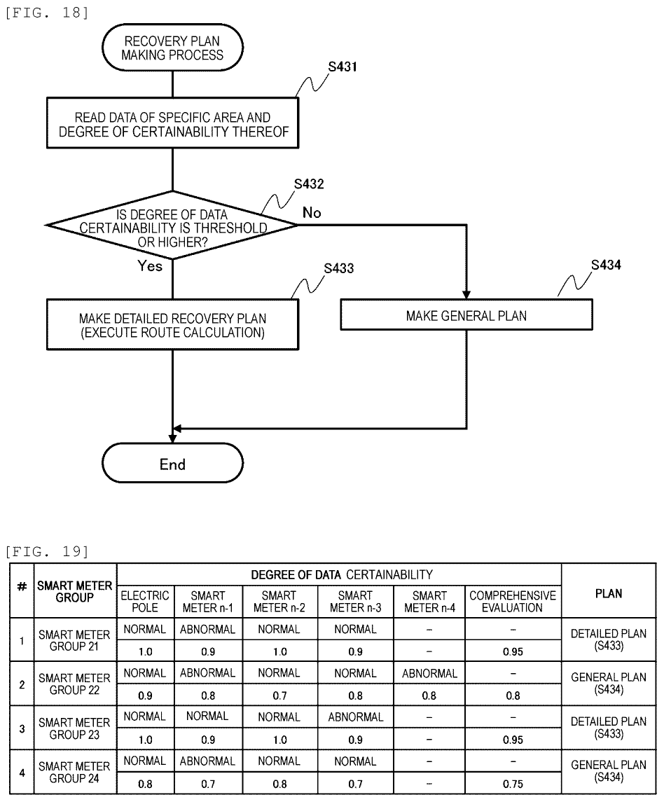

Here, the details of the recovery plan making process will be described using FIG. 18. FIG. 18 is a flowchart illustrating the details of the recovery plan making process in the first embodiment. In Step S431, the recovery plan making unit 12 reads a designated area and the degree of certainability of the equipment in the area from the event data. Here, the designated area is an area where the disaster of the power grid 2 needs to be recovered, and is received from the system manager through the UI unit 15.

In addition, in Step S432, the recovery plan making unit 12 determines whether the degree of certainability read in Step S431 satisfies a predetermined condition, for example, a threshold or more. Here, when a single equipment is present in the designated area, it is desirable to use the degree of certainability of the corresponding equipment (for example, the electric pole or the smart meter). In addition, when a plurality of equipments are present in the designated area, it is desirable to use a representative value (comprehensive evaluation) such as the average value or the total sum of the degrees of certainability of the plurality of equipments. As a result, when the predetermined condition is satisfied (Yes), the process proceeds to Step S433. In addition, when the predetermined condition is not satisfied (No), the process proceeds to Step S434.

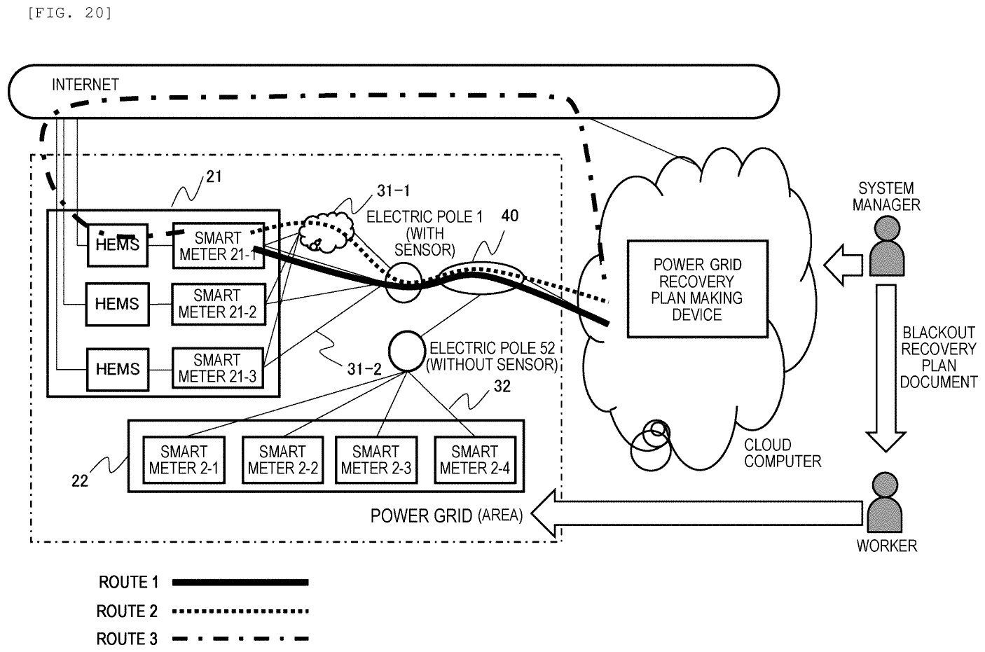

Here, a specific example of the determination of the present step will be described. FIG. 19 is a diagram illustrating a determination process during the recovery plan making in the first embodiment. In FIG. 19, the degree of certainability of each of the equipments is recorded for each of the smart meter groups. The recovery plan making unit 12 calculates the representative value of the degree of certainability of each of the equipments and records the representative value as the comprehensive evaluation. In addition, the recovery plan making unit 12 compares the comprehensive evaluation to a preset threshold (for example, 0.9). As a result, in #1 and 3 where the comprehensive evaluation is the threshold or more, the process proceeds to Step S433. In #2 and 4 where the comprehensive evaluation is less than the threshold, the process proceeds to Step S434. It is desirable that the content illustrated in FIG. 19 is stored in the storage unit 11 as the degree-of-certainability data.

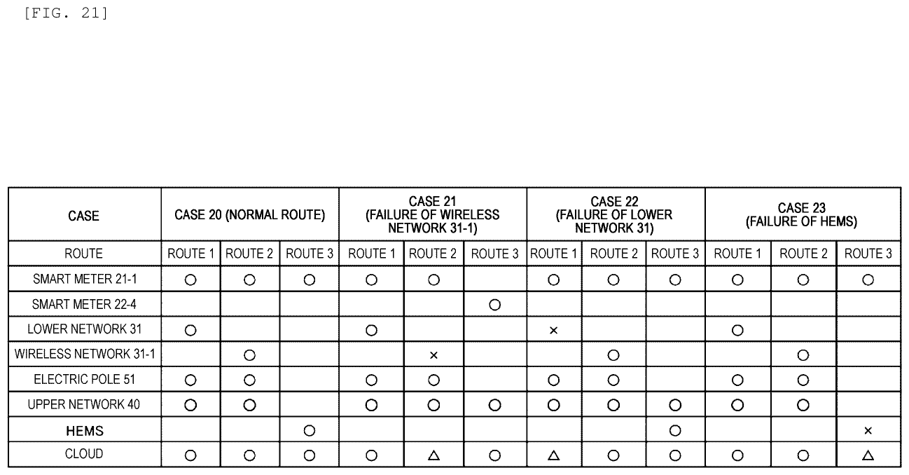

In Step S433, the recovery plan making unit 12 makes a detailed recovery plan using the event data. In order to make the detailed recovery plan, route calculation for allowing the worker to execute work such as repair is executed. The details will be described using FIG. 20. FIG. 20 is a diagram illustrating the process of making the detailed recovery plan in the first embodiment. In the present embodiment, a HEMS (Homer Energy Management System) is connected to each of the smart meters 21-1 to 21-3 of the smart meter group 21. In addition, the power grid recovery plan support apparatus 10 is implemented by cloud computing. In addition, the lower network 31 is connected to the electric pole 51 through a wireless network 31-1 or a wired network 31-2. That is, the network is also redundant. Using this network redundancy, the recovery plan making unit 12 generates routes 1 to 3 as a patrol route of the worker. In addition, in the present embodiment, the routes 1 to 3 illustrated in the drawing are set.

As described below, the recovery plan making unit 12 compares the routes 1 to 3 and specifies a failure portion and a failure occurrence time of the facility. As a result, the recovery plan making unit 12 verifies the failure portion and the failure occurrence time to specify the patrol route. The details are as follows.

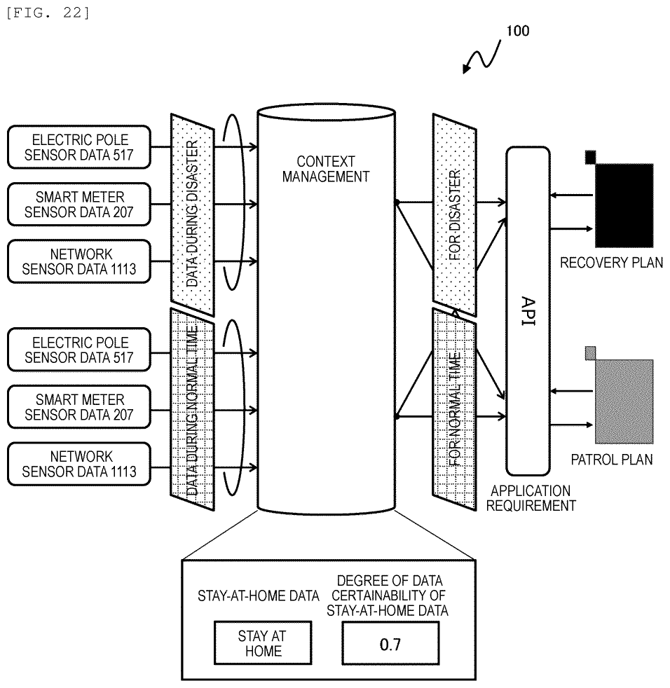

The recovery plan making unit 12 specifies the equipment of each of the routes and the situation of the failure. The route fault situation that is the specified content is illustrated in FIG. 21. Here, a plurality of cases are assumed, and the route fault situation of each of the cases is illustrated. This case includes a case 20 during the normal time, a case 21 where a failure occurs in the wireless network 31-1, a case 22 where a failure occurs in the lower network 31, and a case 23 where a failure occurs in the HEMS. Hereinafter, the verification of the recovery plan making unit 12 for each of the cases where the failure occurs will be described. In the drawing, O represents the normal time, X represents the failure, and Δ represents that the sensor data 111 is not received by the power grid recovery plan support apparatus 10.

First, in the case 21, the recovery plan making unit 12 determines that the failures are the same based on the comparison result of the routes 1 to 3. That is, it can be determined that the failure is the failure of the wireless network 31-1. In addition, in the case 22, the recovery plan making unit 12 can detect the failure of the lower network 31 or the wireless network 31-1 by comparing the routes 1 to 3. In addition, in the case 23, the recovery plan making unit 12 can detect the failure of the HEMS by comparing the routes 1 to 3. In addition, it can be determined that no failure occurs in the upper network 40.

As a result, the network failures can be separated into the failures in the wireless network 31-1, the lower network 31, and the upper network 40, and the degree of data certainability can be improved. Likewise, the state (data) regarding whether the data of another equipment such as the HEMS is normal or abnormal and the degree of data certainability thereof can be improved. This way, by comparing the results of the plurality of routes, the failure portion can be specified, and thus the degree of data certainability can be improved. Hereinabove, the description of Step S433 ends, and the description will be made referring back to FIG. 18.

In Step S434, since the degree of certainability is low, the recovery plan making unit 12 makes a general recovery plan. For example, the recovery plan making unit 12 skips to make the detailed route in Step S433 and makes an approximate route approximate to the maximum value. The recovery plan that is made as described above is output to the system manager or the worker terminal 50 through the UI unit 15. As a result, the worker can execute the recovery work corresponding to the recovery plan. Hereinabove, the description of FIG. 18 ends, and the description will be made referring back to FIG. 6.

In Step S44, the recovery plan making unit 12 notifies a write request of the made recovery plan to the data management unit 13. In response to this notification, in Step S36, the data storage unit 134 of the data management unit 13 stores the recovery plan in the storage unit 11 in response to the write request. Hereinabove, the description of the first embodiment ends. With the present embodiment, even when a failure occurs in the facility such as the power grid 2, an appropriate recovery plan can be made.

### Second Embodiment

In the first embodiment, the recovery plan for the failure during the disaster is made. However, the present invention can also support operation during the so-called normal time. A second embodiment aims to support the operation during the normal time. The configuration of the second embodiment is the same as that of the first embodiment but is different from that of the first embodiment in that the power grid management unit 14 is used. Therefore, at least one of the recovery plan making unit 12 and the power grid management unit 14 in FIG. 1 may be removed, or any one thereof may implement the function of the other unit.

In the second embodiment, as the processes up to Step S42 of FIG. 6, the same processes as those of the first embodiment are executed. In addition, in Step S43, the power grid management unit 14 makes a maintenance plan for maintenance as in the first embodiment. In and after Step S44, the same processes as those of the first embodiment are executed. With the above-described second embodiment, more appropriate operation management such as maintenance of the facility can be implemented. Both of the recovery plan according to the first embodiment and the maintenance plan for the normal time according to the second embodiment may be configured to be made. With the second embodiment, the maintenance plan for the so-called normal time can be implemented to be more suited to an actual condition.

### Third Embodiment

A third embodiment is an example where not only the recovery plan making of the first embodiment but also an application service using the sensor data 111 or the degree of certainability thereof are executed as an example of a job. The application service includes a monitoring service or a delivery service. In the present embodiment, whether a consumer stays at home or the like is determined using the degree of certainability to provide an appropriate service. Hereinafter, the content will be described.

FIG. 22 is a diagram illustrating the summary of a process of a service providing support device 100 according to the third embodiment. In the service providing support device 100, a service support unit is added to the power grid recovery plan support apparatus 10 according to the first or second embodiment. As a result, in the present embodiment, not only the recovery plan making but also generation of a patrol route in the monitoring service or the delivery service are executed. That is, the data reproduction unit 133 executes context management on the sensor data 111 such as the electric pole sensor data 517, and specifies the stay-at-home data of the consumer. At this time, the data reproduction unit 133 calculates the degree of certainability of the stay-at-home data as the degree of certainability. The service support unit generates the patrol route using these values. At this time, it is desirable to execute the process along the process flow illustrated in FIG. 18. It is desirable to output the recovery plan or the patrol plan through an API (Application Programming Interface). The present embodiment skips the making and output of the recovery plan and may be limited to the service support. With the third embodiment, the application service suited to the stay-at-home status, in particular, the generation of the patrol plan can be implemented.

### REFERENCE SIGNS LIST

10: power grid recovery plan support device
11: storage unit
12: recovery plan making unit
13: data management unit
131: data collection unit
132: data evaluation unit
133: data reproduction unit
134: data storage unit
14: power grid management unit
15: UI unit
2: power grid
21 to 24: smart meter group
21-1 to 24-3: smart meter
31 to 34: lower network
40: upper network
50: worker terminal

1. A facility operation support apparatus for supporting operation of a facility, the apparatus comprising:
a communication device configured to receive operation data regarding the operation of the facility;
a storage device connected to the communication device through a communication channel and configured to store a data management program; and
an arithmetic device connected to the communication device and the storage device through the communication channel and
configured to calculate a degree of certainability of the operation data that is defined by a combination of a plurality of elements regarding acquisition of the operation data and represents certainability of the operation data in accordance with the data management program,
to reproduce the operation data according to the degree of certainability, and to store the operation data and the degree of certainability of the operation data in the storage device in association with each other,
wherein an operation plan of the facility is made using the operation data stored in the storage device in accordance with the degree of certainability stored in the storage device.

2. The facility operation support apparatus according to claim 1,
wherein the plurality of elements are an acquisition period element, an acquisition location element, and a characteristic element of the operation data.

3. The facility operation support apparatus according to claim 2,
wherein when the facility is affected by a disaster, the arithmetic device collects the operation data through the communication device in accordance with the data management program and calculates the degree of certainability at the time of the disaster, and
the operation plan of the facility is a recovery plan of the facility.

4. The facility operation support apparatus according to claim 3,
wherein the storage device stores a recovery plan making program, and
the arithmetic device makes the recovery plan of the facility using operation data having a degree of certainability required for making the recovery plan among the operation data stored in the storage device in accordance with the recovery plan making program.

5. The facility operation support apparatus according to claim 4,
wherein the arithmetic device evaluates that the degree of certainability is unstable in accordance with the data management program using an occurrence order of a failure caused by the disaster and a hierarchical relationship in the facility that represent an acquisition period of the operation data,
when the failure is recovered, the arithmetic device executes end-to-end communication using the communication device, and
the arithmetic device detects a hidden failure of the facility through the end-to-end communication.

6. A facility operation support method using a facility operation support apparatus for supporting operation of a facility, the method comprising:
allowing a communication device to receive operation data regarding the operation of the facility;
storing a data management program in a storage device connected to the communication device through a communication channel; and
allowing an arithmetic device connected the communication device and the storage device through the communication channel to calculate a degree of certainability of the operation data that is defined by a combination of a plurality of elements regarding acquisition of the operation data and represents certainability of the operation data in accordance with the data management program,
to reproduce the operation data according to the degree of certainability, and
to store the operation data and the degree of certainability of the operation data in the storage device in association with each other,
wherein an operation plan of the facility is made using the operation data stored in the storage device in accordance with the degree of certainability stored in the storage device.

7. The facility operation support method according to claim 6,
wherein the plurality of elements are an acquisition period element, an acquisition location element, and a characteristic element of the operation data.

8. The facility operation support method according to claim 7,
wherein when the facility is affected by a disaster, the arithmetic device collects the operation data through the communication device in accordance with the data management program and calculates the degree of certainability at the time of the disaster, and
the operation plan of the facility is a recovery plan of the facility.

9. The facility operation support method according to claim 8,
wherein the storage device stores a recovery plan making program, and
the arithmetic device makes the recovery plan of the facility using operation data having a degree of certainability required for making the recovery plan among the operation data stored in the storage device in accordance with the recovery plan making program.

10. The facility operation support method according to claim 9,
wherein the arithmetic device evaluates that the degree of certainability is unstable in accordance with the data management program using an occurrence order of a failure caused by the disaster and a hierarchical relationship in the facility that represent an acquisition period of the operation data,
when the failure is recovered, the arithmetic device executes end-to-end communication using the communication device, and
the arithmetic device detects a hidden failure of the facility through the end-to-end communication.

11. A storage medium that stores a program causing a facility operation support apparatus as a computer for supporting operation of a facility to function as:
an UI unit configured to receive operation data regarding the operation of the facility;
a data evaluation unit configured to calculate a degree of certainability of the operation data that is defined by a combination of a plurality of elements regarding acquisition of the operation data and represents certainability of the operation data in accordance with the data management program;
a data reproduction unit configured to reproduce the operation data according to the degree of certainability; and
a data storage unit configured to store the operation data and the degree of certainability of the operation data in a storage unit in association with each other,
wherein an operation plan of the facility is made using the operation data stored in the storage unit in accordance with the degree of certainability stored in the storage unit.

12. The storage medium that stores the program according to claim 11,
wherein the plurality of elements are an acquisition period element, an acquisition location element, and a characteristic element of the operation data.

13. The storage medium that stores the program according to claim 12, causing the facility operation support apparatus to function as a data collection unit configured to collect the operation data,
wherein when the facility is affected by a disaster, the data collection unit collects the operation data through the UI unit,
the data evaluation unit calculates the degree of certainability at the time of the disaster, and
the operation plan of the facility is a recovery plan of the facility.

14. The storage medium that stores the program according to claim 13, causing the facility operation support apparatus to function as a recovery plan making unit configured to make the recovery plan of the facility,
the data storage unit outputs operation data having a degree of certainability required for making the recovery plan to the recovery plan making unit among the operation data stored in the storage device.

15. The storage medium that stores the program according to claim 14,
wherein the data evaluation unit evaluates that the degree of certainability is unstable using an occurrence order of a failure caused by the disaster and a hierarchical relationship in the facility that represent an acquisition period of the operation data,
when the failure is recovered, the data collection unit executes end-to-end communication, and
the data collection unit detects a hidden failure of the facility through the end-to-end communication.
